(19) United States
(12) Patent Application Publication
(10) Pub. No.: US 2024/0067239 A1
(43) Pub. Date: Feb. 29, 2024

(54) TRAIN CONTROL DEVICE AND SLIP-SLIDE DETECTION METHOD

(71) Applicant: Mitsubishi Electric Corporation, Chiyoda-ku, Tokyo (JP)

(72) Inventors: Masashi ASUKA, Tokyo (JP); Makoto TOKUMARU, Tokyo (JP); Mototsugu KOZAKI, Tokyo (JP); Akira NAKANISHI, Tokyo (JP)

(73) Assignee: Mitsubishi Electric Corporation, Chiyoda-ku, Tokyo (JP)

(21) Appl. No.: 18/260,358

(22) PCT Filed: Jan. 14, 2021
(86) PCT No.: PCT/JP2021/001078

§ 371 Date: Jul. 5, 2023

(51) Int. Cl. B61L 3/00

(52) U.S. Cl. CPC B61L 3/006; B61L 3/002

(57) ABSTRACT

A train control device (20) to be installed on a train (10) includes an acquisition unit (21) that obtains first pulses from a velocity sensor (31) for detecting the first pulses generated on a first axle of the train (10) and obtains second pulses from a velocity sensor (32) for detecting the second pulses generated on a second axle of the train (10), a storage unit (22) that stores the first pulses and the second pulses, and a control unit (23) that determines occurrence or non-occurrence of a slip or a slide of the train (10) based on a pulse ratio, where the pulse ratio is a ratio between a number of first pulses detected during a time period in which the train (10) traveled a given distance among the first pulses, and a number of second pulses detected during a time period in which the train (10) traveled the given distance among the second pulses.

### FIELD

The present disclosure relates to a train control device to be installed on a train, and to a slip-slide detection method.

### BACKGROUND

Occurrence of a slip or a slide on a train is conventionally detected using a detection value from a sensor provided on an axle of the train. Patent Literature 1 discloses a technology in which an on-board device calculates the velocity from velocity pulses detected by rotation detection devices provided on multiple axles, and when an error of each velocity determined based on velocity pulses detected by each rotation detection device exceeds a threshold, determines that a slip or a slide has occurred.

### CITATION LIST

### Patent Literature

Patent Literature 1: WO 2017/195316 A

### SUMMARY OF INVENTION

### Problem to be Solved by the Invention

However, the above conventional technology requires counting of velocity pulses with a short period to detect occurrence of a slip or a slide on a train. This results in a reduced number of velocity pulses countable with a period of counting velocity pulses. This presents a problem in that a large error may occur in the calculated velocity depending on whether a single velocity pulse falls within a certain period.

The present disclosure has been made in view of the foregoing, and it is an object of the present disclosure to provide a train control device capable of detecting a slip or a slide occurring on a train with high accuracy while avoiding a long detection period.

### Means to Solve the Problem

In order to solve the above-described problems and achieve the object, a train control device according to the present disclosure is installed on a train. The train control device includes an acquisition unit to obtain first pulses from a first velocity sensor for detecting the first pulses, and to obtain second pulses from a second velocity sensor for detecting the second pulses, the first pulses having been generated on a first axle of the train, the second pulses having been generated on a second axle of the trains a storage unit to store the first pulses and the second pulses; and a control unit to determine occurrence or non-occurrence of a slip or a slide of the train based on a pulse ratio, the pulse ratio being a ratio between a number of first pulses detected during a time period in which the train traveled a given distance among the first pulses, and a number of second pulses detected during a time period in which the train traveled the given distance among the second pulses.

### Effects of the Invention

The present disclosure is advantageous in that a train control device is capable of detecting a slip or a slide occurring on a train with high accuracy while avoiding a long detection period.

### BRIEF DESCRIPTION OF DRAWINGS

FIG. 1 is a diagram schematically illustrating an example configuration of a train on which a train control device according to a first embodiment is to be installed.

FIG. 2 is a diagram illustrating an example of pulses detected by velocity sensors when neither a slip nor a slide is occurring on the train according to the first embodiment.

FIG. 3 is a diagram illustrating an example of pulses detected by the velocity sensors when a slip or a slide is occurring on the train according to the first embodiment,

FIG. 4 is a diagram illustrating an example of pulses detected by the velocity sensors when a slip or a slide has occurred for a short time period on the train according to the first embodiment,

FIG. 5 is a diagram illustrating an example, as a comparative example, in which the measurement periods for counting pulses detected by the velocity sensors are independent of each other.

FIG. 6 is a first diagram illustrating transition of a slip-or-slide detection state of the train according to the first embodiment.

FIG. 7 is a second diagram illustrating transition of the slip-or-slide detection state of the train according to the first embodiment,

FIG. 8 is a third diagram illustrating transition of the slip-or-slide detection state of the train according to the first embodiment.

FIG. 9 is a fourth diagram illustrating transition of the slip-or-slide detection state of the train according to the first embodiment.

FIG. 10 is a flowchart illustrating an operation of the train control device according to the first embodiment.

FIG. 11 is a diagram illustrating an example of processing circuitry included in the train control device according to the first embodiment when the processing circuitry includes a processor and a memory,

FIG. 12 is a diagram illustrating an example of processing circuitry included in the train control device according to the first embodiment when the processing circuitry includes a dedicated hardware element,

FIG. 13 is a diagram illustrating an illustrative image of wheel diameters of wheels provided on the train according to a second embodiment.

FIG. 14 is a diagram illustrating an illustrative image of a case in which wheel B provided on the train according to the second embodiment has worn,

FIG. 15 is a diagram illustrating an illustrative image of a case in which wheel A provided on the train according to the second embodiment has worn.

FIG. 16 is a flowchart illustrating an operation of the train control device according to the second embodiment.

### DESCRIPTION OF EMBODIMENTS

A train control device and a slip-slide detection method according to embodiments of the present disclosure will be described in detail below with reference to the drawings.

### First Embodiment

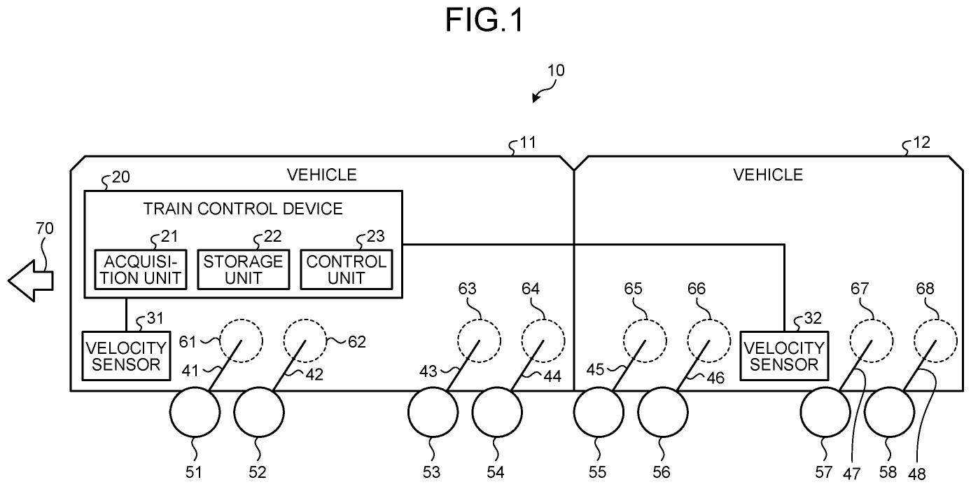

FIG. 1 is a diagram schematically illustrating an example configuration of a train 10 on which a train control device 20 according to a first embodiment is to be installed. The train 10 includes a vehicle 11 and a vehicle 12. The example of FIG. 1 assumes that the train is traveling leftward in the figure as indicated by an arrow 70. FIG. 1 illustrates the train 10 as, but not limited to, a two-car train including the vehicles 11 and 12 by way of example. The train 10 on which the train control device 20 is to be installed may include three or more vehicles.

In the train 10, the vehicle 11 includes the train control device 20, a velocity sensor 31, axles 41 to 44, and wheels 51 to 54 and 61 to 64. The axle 41 has the wheels 51 and 61 attached thereto. The axle 42 has the wheels 52 and 62 attached thereto. The axle 43 has the wheels 53 and 53 attached thereto. The axle 44 has the wheels 54 and 54 attached thereto. The velocity sensor 31 detects a pulse generated on the axle 41. The following description may refer to the velocity sensor 31 as first velocity sensor, the axle 41 as first axle, and the pulse generated on the axle 41 and detected by the velocity sensor 31 as first pulse.

In the train 10, the vehicle 12 includes a velocity sensor 32, axles 45 to 48, and Wheels 55 to 58 and 65 to 68. The axle 45 has the wheels 55 and 65 attached thereto. The axle 45 has the wheels 56 and 66 attached thereto. The axle 47 has the wheels 57 and 67 attached thereto. The axle 48 has the wheels 58 and 68 attached thereto. The velocity sensor 32 detects a pulse generated on the axle 47, The following description may refer to the velocity sensor 32 as second velocity sensor, the axle 47 as second axle, and the pulse generated on the axle 47 and detected by the velocity sensor 32 as second pulse.

As described above, the train control device 20 is installed on the train 10. The train control device 20 includes an acquisition unit 21, a storage unit 22, and a control unit 23.

The acquisition unit 21 obtains a first pulse generated on the axle 41 of the train 10 from the velocity sensor 31, which detects the first pulse. The acquisition unit 21 also obtains a second pulse generated on the axle 47 of the train 10 from the velocity sensor 32, which detects the second pulse. The acquisition unit 21 stores the first pulse and the second pulse obtained, in the storage unit 22.

The storage unit 22 stores first pulses and second pulses obtained by the acquisition unit 21. The storage unit 22 stores the first pulses and the second pulses obtained after a given time. The storage unit 22 stores, for example, the first pulses and the second pulses obtained by the acquisition unit 21 after the train 10 starts operation of a certain day.

The control unit 23 compares the number of first pulses detected during a time period in which the train. 10 traveled a given distance among the first pulses stored in the storage unit 22, and the number of second pulses detected during a time period in which the train 10 traveled the given distance among the second pulses stored in the storage unit 22, The control unit 23 determines occurrence or non-occurrence of a slip or a slide of the train 10 based on a pulse ratio, which is a result of comparison between the number of first pulses and the number of second pulses. The given distance is, specifically, an axle-to-axle distance of the train 10 between the axle 41, which is a first axle, monitored for detection by the velocity sensor 31, and the axle 47, which is a second axle, monitored for detection by the velocity sensor 32.

An operation of the train control device 20 to determine whether a slip or a slide has occurred on the train 10 will next be described. The control unit 23 of the train control device 20 calculates, as described above, a pulse ratio between the number of first pulses detected by the velocity sensor 31 and the number of second pulses detected by the velocity sensor 32 during a time period in which the train 10 travels the axle-to-axle distance, Note that it is assumed that the train control device 20 stores, in the control unit 23 or in the storage unit 22, a pulse ratio in normal operation when neither a slip nor a slide is occurring on the train 10. The control unit 23 calculates the pulse ratio, and compares the calculated pulse ratio with the pulse ratio in normal operation, periodically while the train 10 is running. The control unit determines that a slip or a slide has occurred on the train 10 when a difference is determined to be greater than or equal to a given threshold based on the comparison of the calculated pulse ratio with the pulse ratio in normal operation. Note that the pulse ratio in normal operation may hereinafter be referred to as normal-operation pulse ratio.

A slip or a slide occurs on the train 10, in general, when a foreign matter such as water, oil, or a fallen leaf exists on rails (not illustrated) with which the wheels 51 to 58 and 61 to 68 of the train 10 are to come into contact, thereby reducing friction force between the wheels 51 to 58 and 61 to 68 and the rails, Thus, a slip or a slide occurs on the train 10 when the wheels 51 to 58 and 61 to 68 reach specific points on the rails. The velocity sensors 31 and 32 are accordingly installed on the train 10 to be spaced sufficiently apart from each other. This creates, on the train 10, a situation in which even when a slip or a slide has occurred on the wheels 51 and Gi positioned forward in the travel direction of the train 10 and attached to the axle 41 monitored for detection by the velocity sensor 31, neither a slip nor a slide has yet occurred on the wheels 57 and 57 positioned rearward in the travel direction of the train 10 and attached to the axle 47 monitored for detection by the velocity sensor 32. The following description refers to the Wheels 51 and 61 as front wheels, and the wheels 87 and 67 as rear wheels. The axle 41 has the front wheels attached thereto, which wheels are the wheels 51 and 61 provided on the train 10 at a forward position in the travel direction of the train 10. The axle 47 has the rear wheels attached thereto, which wheels are the Wheels 57 and 57 provided on the train 10 at a rearward position in the travel direction of the train 10.

That is, the train 10 operates such that even when a slip or a slide has occurred on the front wheels, neither a slip nor a slide occurs on the rear wheels before the train 10 travels axle-to-axle distance. The control unit 23 of the train control device 20 thus constantly makes a comparison on the number of pulses that have been generated on the axle 41 having the front wheels attached thereto daring a measurement period from the present time, where the measurement period is a time period in which pulses are generated as many as the number equivalent, to the axle-to-axle distance, on the axle 47 having the rear wheals attached thereto. The control unit 23 compares the result of comparison, i.e., the pulse ratio, with the pulse ratio in normal operation, and can thus determine whether a slip or a slide has occurred on the train 10,

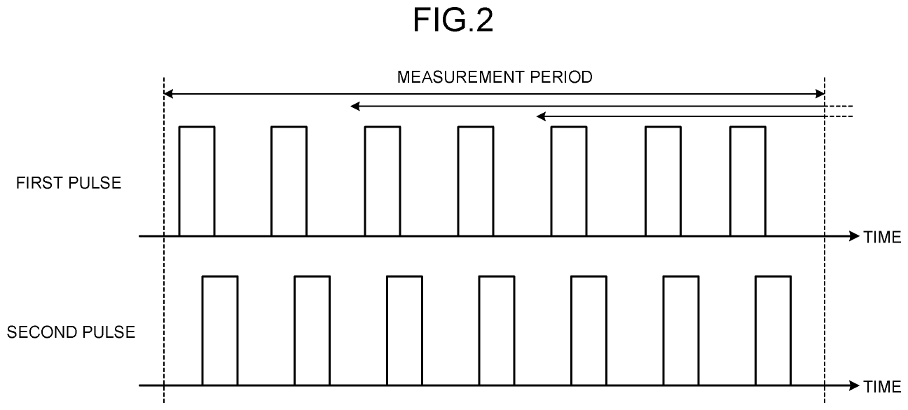

FIG. 2 is a diagram illustrating an example of pulses detected by the velocity sensors 31 and 32 when neither a slip nor a slide is occurring on the train 10 according to the first embodiment. In FIG. 2, the upper part illustrates the first pulses detected by the velocity sensor 31, and the lower part illustrates the second pulses detected by the velocity sensor 32, In addition, the horizontal axes in FIG. 2 represent time, FIG. 2 illustrates a case in which a difference between the pulse ratio in a measurement period from the present time and a given pulse ratio in normal operation is less than a threshold, where the measurement period is a time period in which pulses are generated as many as the number equivalent to the axle-to-axle distance, on the axle 47 having the rear wheels attached thereto. Note that FIG. 2 schematically illustrates the pulses for simplicity of illustration, and much more pulses are actually detected in the measurement period. This also applies to the diagrams referred to in the following description.

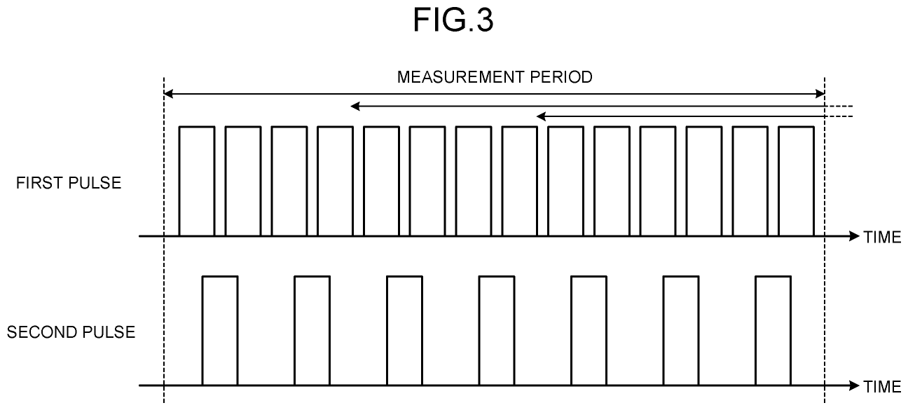

FIG. 3 is a diagram illustrating an example of pulses detected by the velocity sensors 31 and 32 when a slip or a slide is occurring on the train 10 according to the first embodiment. In FIG. 3, the upper part illustrates the first pulses detected by the velocity sensor 31, and the lower part illustrates the second pulses detected by the velocity sensor 32. In addition, the horizontal axes in FIG. 3 represent time. FIG. 3 illustrates a case in which the difference between the pulse ratio in the measurement period from the present time and the given pulse ratio in normal operation is greater than or equal to a threshold, where the measurement period is a time period in which pulses are generated as many as the number equivalent to the axle-to-axle distance, on the axle 47 having the rear wheels attached thereto.

As described above, the control unit 23 compares the pulse ratio in each of the measurement periods with the given pulse ratio in normal operation, and can thus determine whether a slip or a slide has occurred on the train 10. In this operation, the control unit 23 detects the number of first pulses and the number of second pulses, that is, the control unit 23 calculates the pulse ratio, for each of the measurement periods, where the multiple consecutive measurement periods partially overlap each other as illustrated in FIGS. 2 and 3, rather than a next measurement, period starts after one measurement period ends. The start time of each measurement period is shifted by, for example, about 100 milliseconds or 200 milliseconds. This period of about 100 milliseconds or 200 milliseconds is the interval of calculation of the pulse ratio, that is, of checking the pulse ratio, in the measurement period performed by the control unit 23. That is, the control unit checks the pulse ratio at an interval shorter than the time period in which the train 10 travels the axle-to-axle distance. This enables the control unit 23 to determine whether a slip or a slide has occurred on the train 10 using pulses detected by the velocity sensors 31 and 32 while the train 10 travels the axle-to-axle distance, at an interval shorter than the measurement period in which the train 10 travels the axle-to-axle distance. When the axle-to-axle distance is sufficiently longer than a distance equivalent to the pulse spacing of detection of the first pulses and the second pulses, an error that may occur in the pulse ratio calculated by the control unit 23 will be very small even when an error corresponding to a single pulse has occurred in the number of pulses included in each measurement period.

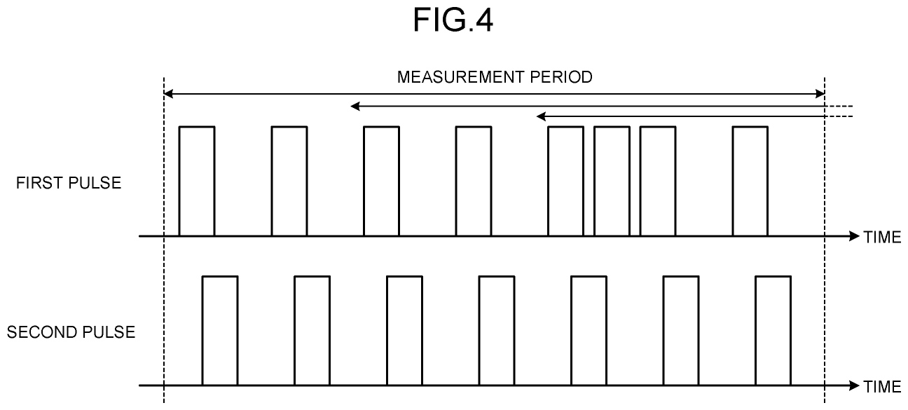

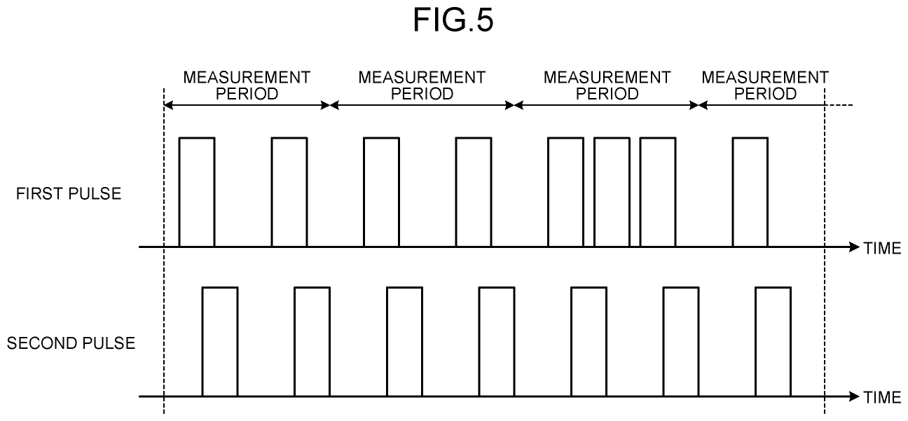

Note that when a slip or a slide has occurred on the train 10 as illustrated in FIG. 3, the control unit 23 is reasonably expected to determine that a slip or a slide has occurred on the train 10 for multiple consecutive measurement periods. The control unit 23 may accordingly determine whether a slip or a slide has actually occurred based on the number of consecutive determinations that a slip or a slide of the train 10 has occurred. FIG. 4 is a diagram illustrating an example of pulses detected by the velocity sensors 31 and 32 when a slip or a slide has occurred for a short time period on the train 10 according to the first embodiment. In FIG. 4, the upper part illustrates the first pulses detected by the velocity sensor 31, and the lower part illustrates the second pulses detected by the velocity sensor 32. In addition, the horizontal axes in FIG. 4 represent time. FIG. 5 is a diagram illustrating an example, as a comparative example, in which the measurement periods for counting pulses detected by the velocity sensors 31 and 32 are independent of each other. FIG. 5 assumes a case in which the measurement periods for counting the number of pulses are independent of each other, i.e., a case in which a next measurement period starts after one measurement period ends. In FIG. 5, each measurement period is a time period corresponding to the shift amount of each measurement period illustrated in FIG. 4. In such case, an unexpected, sudden pulse detected as a first pulse in a certain measurement period may be identified as a false detection of the velocity sensor 31 because no unexpected, sudden pulse is detected in the next measurement period.

In contrast, the control unit 23 in FIG. 4 is capable of determining that a slip or a slide has occurred on the train 10 when a slip or a slide has occurred on the train 10 even for a short time, based on the pulse ratios in multiple measurement periods. Thus, when the number of consecutive determinations that a slip or a slide of the train 10 has occurred is greater than or equal to a given number of times, the control unit 23 determines that a slip or a slide has actually occurred on the train 10. When the number of consecutive determinations that a slip or a slide of the train 10 has occurred is less than the given number of times, the control unit 23 determines that neither a slip nor a slide has actually occurred on the train 10.

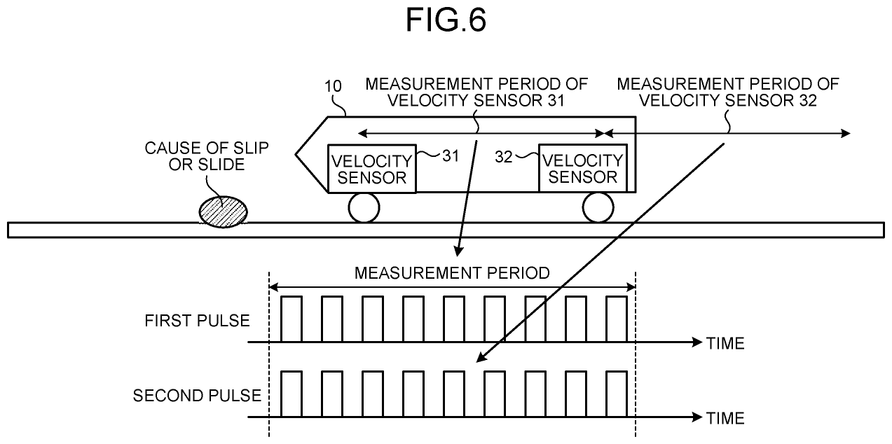

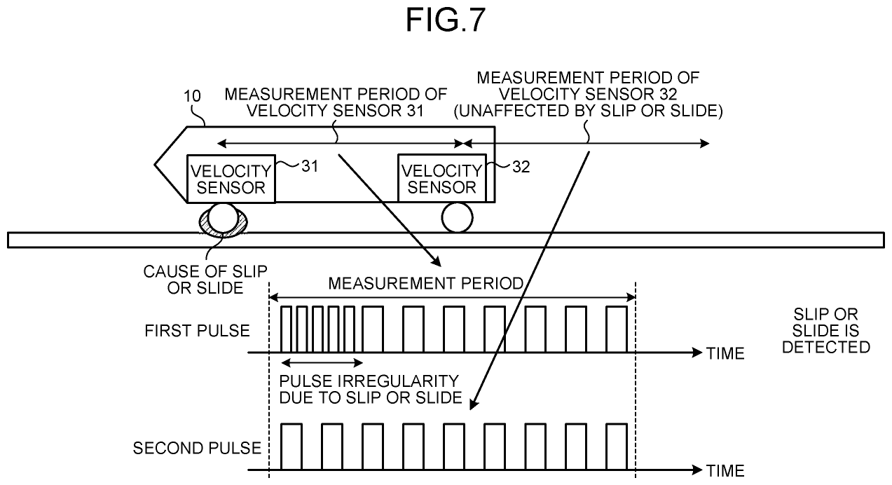

In addition, use of the first pulses detected by the velocity sensor 31 and the second pulses detected by the velocity sensor 32 enables the control unit 23 to subsequently detect a slip or a slide that has occurred even for a short time FIG. 6 is a first diagram illustrating transition of a slip-or-slide detection state of the train 10 according to the first embodiment. FIG. 6 illustrates a state similar to the state in the case of FIG. 2, and neither a slip nor a slide has been detected on neither of the first pulses from the velocity sensor 31 and the second pulses from the velocity sensor 32. FIG. 7 is a second diagram illustrating transition of the slip-or-slide detection state of the train 10 according to the first embodiment. FIG. 7 illustrates a state in which the wheels 51 and 61, attached to the axle 41 monitored for detection by the velocity sensor 31, have passed over a cause of a slip or a slide, thereby causing a pulse irregularity due to a slip or a slide to occur on the first pulses from the velocity sensor 31. In FIG. 7, the wheels 57 and 67, attached to the axle 47 monitored for detection by the velocity sensor 32, have not yet passed over the cause of a slip or a slide, and are thus in a state similar to the state in the case of FIG. 6.

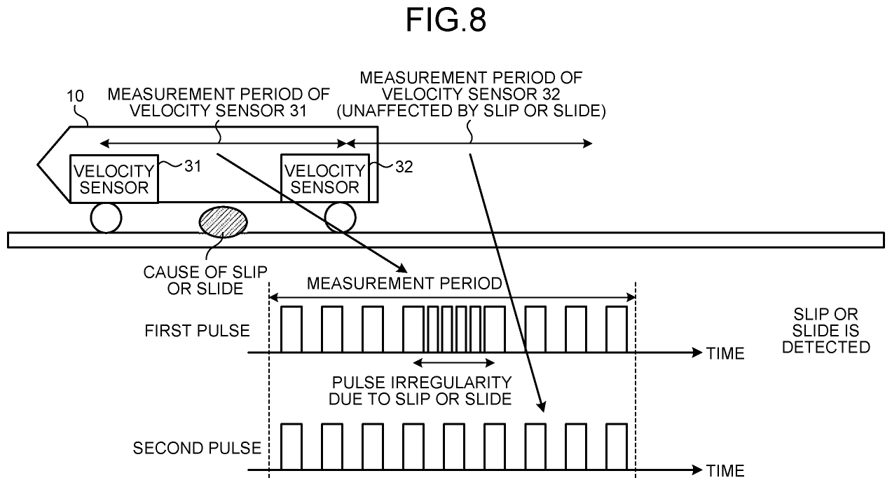

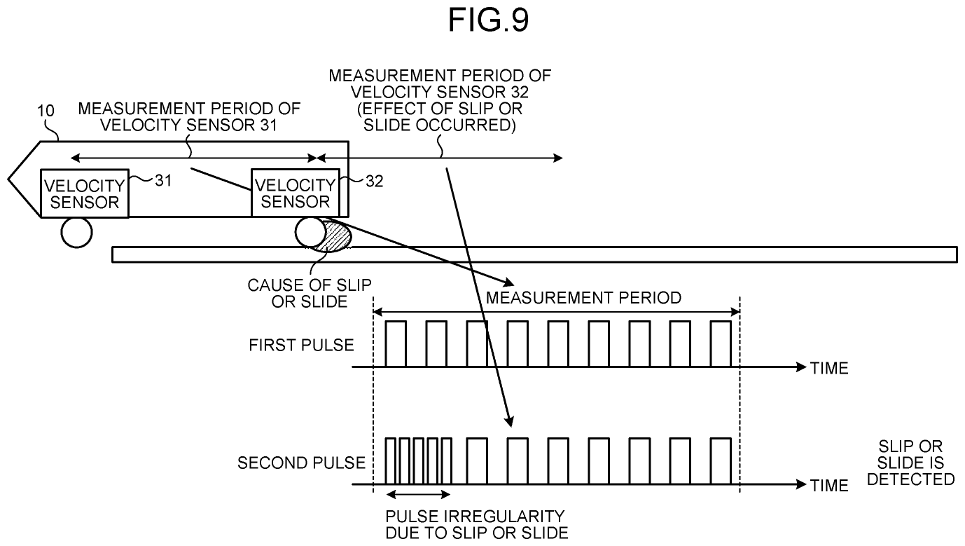

B is a third diagram illustrating transition of the slip-or-slide detection state of the train 10 according to the first embodiment. FIG. 8 illustrates a state in which, similarly to FIG. 1, the wheels 51 and 61, attached to the axle 41 monitored for detection by the velocity sensor 31, have passed over the cause of a slip or a slide, thereby causing a pulse irregularity due to a slip or a elide to occur on the first pulses from the velocity sensor 31 because the train 10 is within the measurement period of the velocity sensor 31. In FIG. 8, the wheels 57 and 7, attached to the axle 47 monitored for detection by the velocity sensor 32, have not yet passed over the cause of a slip or a slide, and are thus in a state similar to the state in the case of FIG. 6, FIG. 9 is a fourth diagram illustrating transition of the slip-or-slide detection state of the train 10 according to the first embodiment, FIG. 9 illustrates a state in which the train has traveled the axle-to-axle distance since the wheels 51 and 61, attached to the axle 41 monitored for detection by the velocity sensor 31 passed over the cause of a slip or a slide, in which state the irregularity of pulses due to a slip or a slide has been resolved on the first pulses from the velocity sensor 31. On the other hand, FIG. 9 also illustrates a state in which the wheels 57 and 67, attached to the axle 47 monitored for detection by the velocity sensor 32, have passed over the cause of a slip or a slide, thereby causing a pulse irregularity due to a slip or a slide to occur on the second pulses from the velocity sensor 32. As described above, use of a section equivalent to the axle-to-axle distance for detecting pulses by the velocity sensors 31 and 32 allows the control unit 23 to continue to subsequently detect the cause of a slip or a slide for a certain time after the situation of FIG. 9. That is, the control unit 23 is capable of subsequently detecting a slip or a slide using the velocity sensor 32 even after the velocity sensor 31 can no longer detect a slip or a slide.

Note that the train control device 20 may store a predetermined pulse ratio in normal operation in the control unit 23 or in the storage unit. 22, or may calculate a pulse ratio in normal operation by the control unit 23 during coasting operation of the train 10 during which neither a slip nor a slide is occurring on the train 10, and store the pulse ratio in normal operation in the control unit 23 or in the storage unit 22, In the case in which the control unit 23 calculates the pulse ratio in normal operation, the control unit 23 may periodically calculate and update the pulse ratio in normal operation.

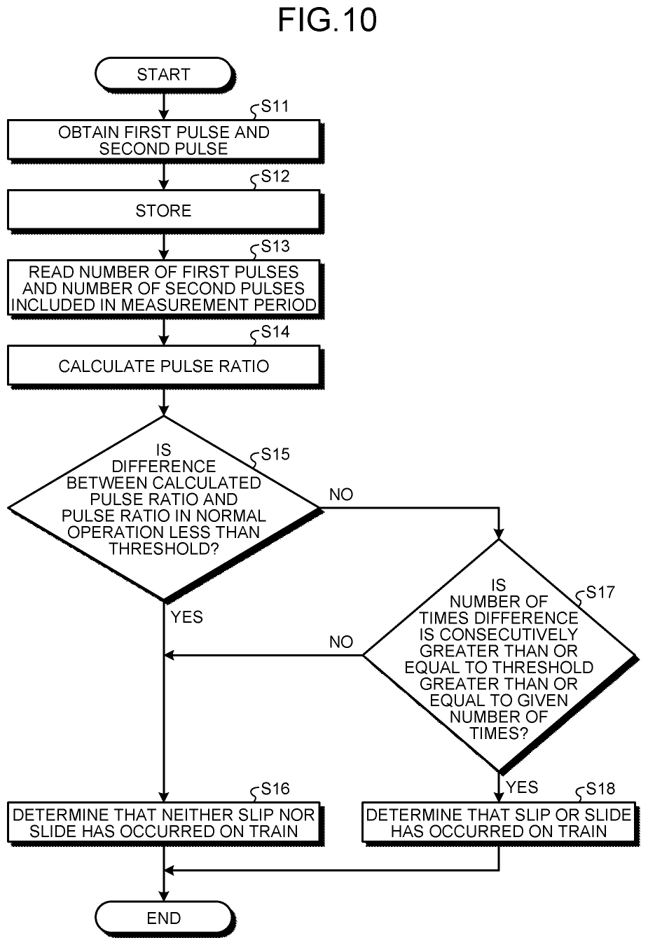

An operation of the train control device 20 will next be described using a flowchart, FIG. 10 is a flowchart illustrating an operation of the train control device 20 according to the first embodiment. In the train control device 20, the acquisition unit 21 obtains a first pulse from the velocity sensor 31, and obtains a second pulse from the velocity sensor 32 (step S11). The acquisition unit 21 stores the first pulse and the second pulse in the storage unit 22 (step S12). The control unit 23 reads the number of first pulses and the number of second pulses included in the measurement period at the present time among the first pulses and the second pulses stored in the storage unit 22 (step S13), The control unit 23 calculates a pulse ratio using the number of first pulses and the number of second pulses that have been read (step S14).

The control unit 23 compares the calculated pulse ratio with the pulse ratio in normal operation step S15), When a difference between the calculated pulse ratio and the pulse ratio in normal operation is less than a threshold (step S15: Yes), the control unit 23 determines that neither a slip nor a slide has occurred on the train (step S16). When the difference between the calculated pulse ratio and the pulse ratio in normal operation is greater than or equal to the threshold (step S15: No), the control unit 23 counts the number of times the difference between the calculated pulse ratio and the pulse ratio in normal operation is consecutively greater than or equal to the threshold (step S17). When the number of times the difference is consecutively greater than or equal to the threshold is less than a given number of times (step S17: No), the control unit 23 determines that neither a slip nor a slide has occurred on the train 10 (step S16), When the number of times the difference is consecutively greater than or equal to the threshold is greater than or equal to the given number of times (step S17: Yes), the control unit 23 determines that a slip or a elide has occurred on the train 10 (step S18). The train control device 20 periodically performs the operation of the flowchart illustrated in FIG. 10 at an interval equivalent to the shift amount of the measurement period described above, an interval of about 100 milliseconds or 200 milliseconds.

A hardware configuration of the train control device 20 will next be described. In the train control device 20, the acquisition unit 21 is an interface such as a communication device. The storage unit 22 is a memory. The control unit 23 is implemented in a processing circuitry. The processing circuitry may be a processor that executes a program stored in a memory and the memory, or may be a dedicated hardware element.

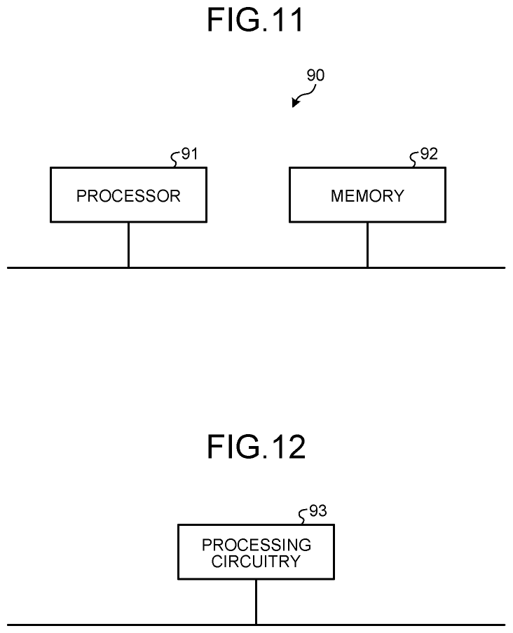

FIG. 11 is a diagram illustrating an example of a processing circuitry 90 included in the train control device 20 according to the first embodiment when the processing circuitry 90 includes a processor 91 and a memory 92. When the processing circuitry 90 includes the processor 91 and the memory 2, each functionality of the processing circuitry 90 of the train control device 20 is implemented in software, firmware, or a combination of software and firmware. The software or firmware is described in the form of a program, and is stored in the memory 92. The processing circuitry 90 provides each functionality in such a manner that the processor 91 reads and executes a program stored in the memory 92, That is, the processing circuitry 90 includes the memory 92 for storing programs that cause the processing of the train control device 20 to be performed. In addition, it can also be said that these programs cause a computer to perform a procedure and a method of the train control device 20.

In this respect, the processor 91 may be a central processing unit (CPU), a processing unit, a computing unit, a microprocessor, a microcomputer, a digital signal processor (DSP), or the like. In addition, the memory 92 is, for example, a non-volatile or volatile semiconductor memory such as a random access memory (RAM), a read-only memory (ROM), a flash memory, an erasable programmable ROM (EPROM), or an electrically EPROM (EEPROM) (registered trademark) a magnetic disk, a flexible disk, an optical disk, a compact disc, a MiniDisc, a digital versatile disc (DVD) or the like,

FIG. 12 is a diagram illustrating an example of a processing circuitry 93 included in the train control device 20 according to the first embodiment when the processing circuitry 93 includes a dedicated hardware element. When the processing circuitry 93 includes a dedicated hardware element, the processing circuitry 93 illustrated in FIG. 12 is, for example, a single circuit, a set of multiple circuits, a programmed processor, a parallel programmed processor, an application specific integrated circuit (ASIC), a field programmable gate array (FPGA), or a combination thereof. Each functionality of the train control device 20 may be implemented in the processing circuitry 93 on a function-by-function basis, or the functionalities may together be implemented in the processing circuitry 93.

Note that each functionality of the train control device 20 may be implemented partially in a dedicated hardware element and partially in software or firmware. Thus, the processing circuitry can provide each functionality described above in a dedicated hardware element, software, firmware, or a combination thereof.

As described above, according to this embodiment, the train control device 20 calculates a pulse ratio of pulses detected by the velocity sensors 31 and 32 in a measurement period, which is a time period in which the train 10 travels the axle-to-axle distance between the axles 41 and 47 monitored for detection by the velocity sensors 31 and 32 of the train 10. The train control device 20 then compares the calculated pulse ratio with the pulse ratio in normal operation to determine whether a slip or a slide has occurred on the train 10, This enables the train control device 20 to detect a slip or a slide occurring on the train 10 with high accuracy while avoiding a long detection period.

### Second Embodiment

A second embodiment will be described with respect to a case in which the control unit 23 of the train control device 20 corrects the wheel diameter of a wheel of the train 10.

In the second embodiment, the train 10 and the train control device 20 are configured similarly to the train 10 and the train control device 20 in the first embodiment illustrated in FIG. 1, In normal running control of the train 10, the train control device 20 estimates the speed of the train 10, the travel distance of the train 10, and the like using the pulses obtained from the velocity sensors 31 and 32. Estimation of the speed of the train 10, the travel distance of the train 10, and the like requires information of wheel diameters of the wheels 51 and 61, attached to the axle 41 monitored for detection by the velocity sensor 31, and of wheel diameters of the wheels 57 and 67, attached to the axle 47 monitored for detection by the velocity sensor 32, However, the wheels 51 to 58 and 61 to 68 of the train 10 undergo a decrease in the wheel diameter due to gradual wear caused by running of the train 10. An incorrect value of the wheel diameter may cause a large error in the speed of the train 10, the travel distance of the train 10, and the like that are estimated by the train control device 20. Thus, when the foregoing pulse ratio has changed in coasting operation of the train 10, during which neither a slip or a slide occurs on the train 10, the control unit 23 of the train control device 20 determines that one of the wheels has worn, and provides control to correct the wheel diameter of the applicable wheel. Note that for simplicity of illustration, the wheels 51 to 58 and 61 to 68 on the train 10 are assumed to be of a same type.

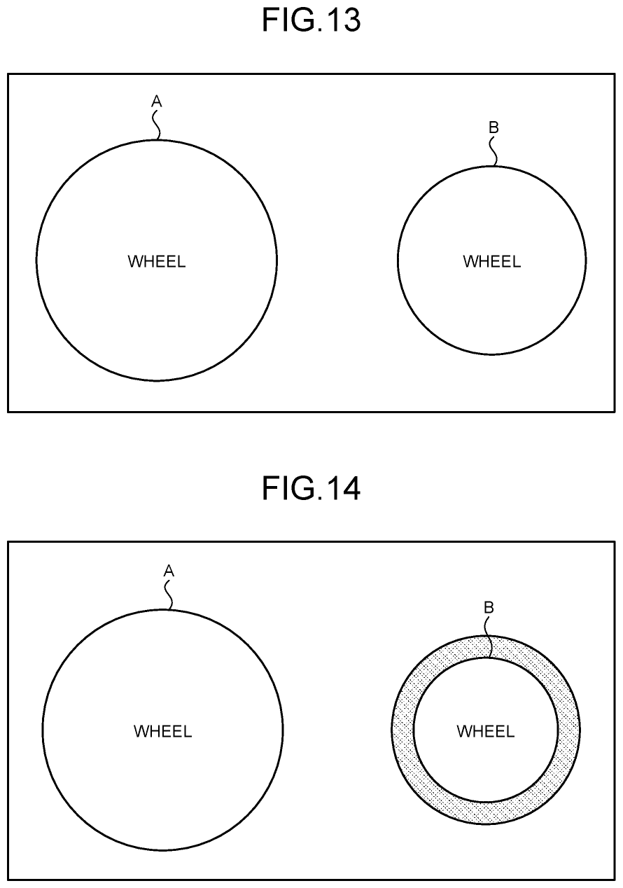

FIG. 13 is a diagram illustrating an illustrative image of wheel diameters of wheels provided on the train 10 according to the second embodiment. For simplicity of illustration, the following description designates the wheels 51 and 61, attached to the axle 41 monitored for detection by the velocity sensor 31, as wheel A, and the wheels 57 and 67, attached to the axle 47 monitored for detection by the velocity sensor 32, as wheel B. In addition, the initial wheel diameter at the present time of wheel A is designated R_a. The initial wheel diameter at the present time of wheel B is designated R_b. The wheal diameter ratio of the initial wheel diameter R_a of wheel A to the initial wheel diameter R_b of wheel B is designated “R_a/R_b=Ratio0”, In this respect, the initial wheel diameter R_a is greater than the initial wheel diameter R_b, meaning that Ratio0>1. Note that the wheel diameter ratio Ratio0 can be expressed as “Ratio0=number of second pulses/number of first pulses” using the number of first pulses and the number of second pulses described above, That is, “initial wheel diameter R_a”:“initial wheel diameter R_b”=“the number of second pulses”:“the number of first pulses”.

A case will next be described in which a wheel diameter ratio Ratio1 after a change exceeds the initial wheel diameter ratio Ratio0. FIG. 14 is a diagram illustrating an illustrative image of a case in which wheel B provided on the train 10 according to the second embodiment has worn, Because the wheel diameter will never increase unless the wheel is exchanged, the control unit 23 corrects the wheel diameter of wheel B when Ratio1>Ratio0. The new wheel diameter R_b₁ after correction can be calculated by “R_b₁=R_a×(1/Ratio1)”, In the case of Ratio1>Ratio0, the control unit 23 may use a threshold to determine that. Ratio1=Ratio0, and determine not to correct the wheel diameter of wheel B, when the difference is less than the threshold.

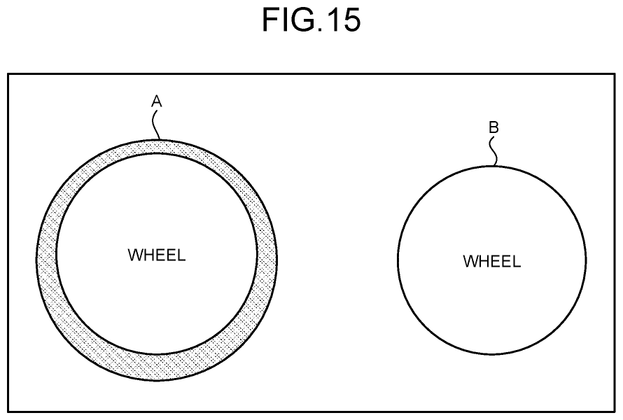

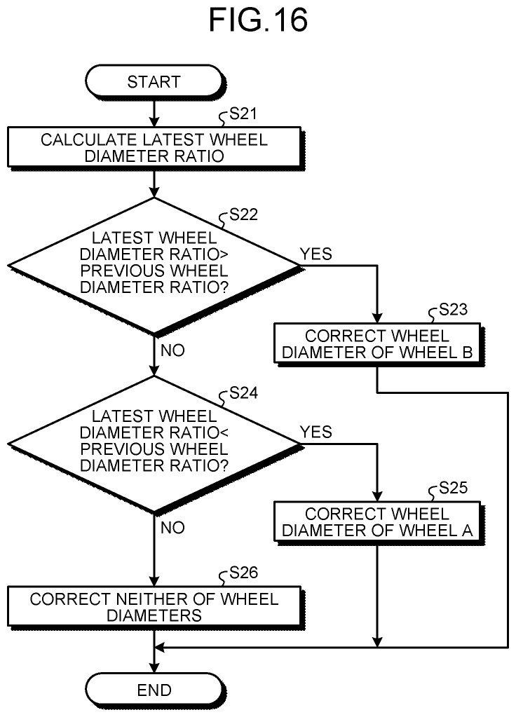

A case will next be described in which the wheel diameter ratio Ratio1 after a change falls below the initial wheel diameter ratio Ratio0. FIG. 15 is a diagram illustrating an illustrative image of a case in which wheel A provided on the train 10 according to the second embodiment has worn. Because the wheel diameter will never increase unless the wheel is exchanged, the control unit 23 corrects the wheel diameter of wheel A when Ratio1<Ratio0. The new wheel diameter R_a₁ after correction can be calculated by “R_a₂=R_b×Ratio1”. In the case of Ratio1<Ratio0, the control unit 23 may use a threshold to determine that Ratio1=Ratio0, and determine not to correct the wheel diameter of wheel A, when the difference is less than the threshold.

Note that the control unit 23 is also capable of correcting the wheel diameter more accurately. The following description describes the case of Ratio1>Ratio0 as an example, but is also applicable to the case of Ratio1<Ratio0. First, the control unit 23 calculates a first new wheel diameter R_b₁ of wheel B by “R_b₁=R_a×(1/Ratio1)” using the above method. Next, the control unit 23 calculates a second new wheel diameter R_b₂ of wheel B when wheel A has maximally worn in the travel distance of the train 10. In this respect, a new wheel diameter R_a₂ of wheel A is “R_a₂=R_a−α×D”, where α (m/m) represents the maximum wear amount of the wheel diameter per unit travel distance of the train 10, and D (m) represents the travel distance of the train 10 traveled before a deviation of the wheel diameter ratio is detected. Accordingly, the control unit 23 calculates the second new wheel diameter R_b₂ of wheel B in consideration of the maximum wear of wheel A by “R_b₂=R_a₂×(1/Ratio1)”. The control unit 23 also calculates a third new wheel diameter R_b₃ of wheel B in consideration of the maximum wear amount of wheel B for the travel distance of the train 10. The control unit 23 calculates the third new wheel diameter R_b₃ of wheel B in consideration of the maximum wear of wheel B by “R_b₃=R_b−α×D”.

The control unit 23 selects a maximum wheel diameter and a minimum wheel diameter from the first new wheel diameter R_b₁, the second new wheel diameter R_b₂, and the third new wheel diameter R_b₃. Specifically, the control unit 23 selects a maximum wheel diameter R_b_max by “maximum wheel diameter R_b_max=MAX(R_b₁, R_b₂, R_b₃)”, In addition, the control unit 23 selects a minimum wheel diameter R_b man by “minimum wheel diameter R_b_min=MIN(R_b₁, R_b₂, R_b₃)”. The control unit 23 can estimate the speed and the travel distance of the train 10 and the like using the maximum wheel diameter R_b_max and the minimum wheel diameter R_b_min. Note that the control unit determines detection of a slip or a slide in the first embodiment based on the number of pulses detected on each wheel. The detect ion of a slip or a slide can therefore be performed without being affected by a large error in individual wheel diameter even when such a large error occurs.

As described above, the control unit 23 calculates a value obtained by division of the number of second, pulses by the number of first pulses as a wheel diameter ratio, and periodically makes a comparison of the wheel diameter ratio, where the wheel diameter ratio is a value obtained by division of a first wheel diameter of a first wheel attached to a first axle by a second wheel diameter of a second wheel attached to a second axle. When the wheel diameter ratio exceeds a previous value of the wheel diameter ratio, the control unit 23 determines that the second wheel has worn, and corrects the second wheel diameter. When the wheel diameter ratio falls below the previous value of the wheel diameter ratio, the control unit 23 determines that the first wheel has worn, and corrects the first wheel diameter. The control unit 213 estimates the speed of the train 10 and the travel distance of the train 10 using the first wheel diameter and the second wheel diameter.

An operation of the train control device 20 will next be described using a flowchart. FIG. 1 is a flowchart illustrating an operation of the train control device 20 according to the second embodiment. In the train control device 20, the control unit 23 calculates a latest wheel diameter ratio (step S21). The control unit 23 makes a comparison and determines whether the latest wheel diameter ratio calculated is greater than a previously calculated wheel diameter ratio by comparison (step S22). When the latest wheel diameter ratio is greater than the previously calculated wheel diameter ratio (step S22: Yes), the control unit 23 corrects the wheel diameter of wheel B (step S23), When the latest wheel diameter ratio is not greater than the previously calculated wheel diameter ratio (step S22: No), the control unit 23 makes a comparison and determines whether the latest wheel diameter ratio calculated is less than the previously calculated wheel diameter ratio by comparison (step S24). When the latest wheel diameter ratio is less than the previously calculated wheel diameter ratio (step S24: Yes), the control unit 23 corrects the wheel diameter of Wheel A (step S25), When the latest wheel diameter ratio is not less than the previously calculated wheel diameter ratio (step S24: No), the control unit 23 determines that the latest wheel diameter ratio is equal to the previously calculated wheel diameter ratio, corrects neither of the wheel diameters of wheel A and of Wheel B (step S26), and terminates the process.

As described above, according to this embodiment, the train control device 20 corrects the wheel diameter when the train control device 20 has detected occurrence of wear on wheel A or B of the train 10. This enables the train control device 20 to use a corrected wheel diameter and thus to estimate the speed of the train 10, the travel distance of the train 10, and the like with high accuracy in estimating these values.

The configurations described in the foregoing embodiments are merely examples. These configurations may be combined with a known other technology and configurations of different embodiments may be combined together, More part of such configurations may be omitted and/or modified without departing from the spirit thereof.

### REFERENCE SIGNS LIST

10 train; 11, 12 vehicle; 20 train control device; 21 acquisition unit; 22 storage unit; 23 control unit; 31, 32 velocity sensor; 41-48 axle; 51-58, 61-68 wheel.

1. A train control device to be installed on a train, the train control device comprising:
an acquisition circuitry to obtain first pulses from a first velocity sensor for detecting the first pulses, and to obtain second pulses from a second velocity sensor for detecting the second pulses, the first pulses having been generated on a first axle of the train, the second pulses having been generated on a second axle of the train;
a storage circuitry to store the first pulses and the second pulses; and
a control circuitry to determine occurrence or non-occurrence of a slip or a slide of the train by comparison, with a pulse ratio in normal operation, of a pulse ratio between a number of first pulses detected during a time period in which the train traveled a given distance among the first pulses, and a number of second pulses detected during a time period in which the train traveled the given distance among the second pulses, the pulse ratio in normal operation being a pulse ratio when neither a slip nor a slide is occurring.

2. The train control device according to claim 1, wherein
the given distance is an axle-to-axle distance of the train between the first axle and the second axle.

3. The train control device according to claim 1, wherein
the first axle has front wheels attached to the first axle and the second axle has rear wheels attached to the second axle, the front wheels each being a wheel provided on the train at a forward position in a travel direction of the train, the rear wheels each being a wheel provided on the train at a rearward position in the travel direction of the train.

4. The train control device according to claim 1, wherein
the control circuitry detects the number of first pulses and the number of second pulses in each of a plurality of measurement periods, consecutive ones of the measurement periods partially overlapping each other in time, and
the control circuitry checks the pulse ratio at an interval equivalent to a shift amount of a start time of each of the measurement periods.

5. The train control device according to claim 1, wherein
the control circuitry determines that neither a slip nor a slide has occurred on the train when a difference between the pulse ratio and a normal-operation pulse ratio is less than a threshold, and determines that neither a slip nor a slide has occurred on the train when the difference between the pulse ratio and the normal-operation pulse ratio is greater than or equal to the threshold.

6. The train control device according to claim 5, wherein
the control circuitry determines that a slip or a slide has actually occurred on the train when a number of consecutive determinations that a slip or a slide of the train has occurred is greater than or equal to a given number of times, and determines that neither a slip nor a slide has actually occurred on the train when the number of consecutive determinations that a slip or a slide of the train has occurred is less than the given number of times.

7. The train control device according to claim 1, wherein
the control circuitry calculates a value obtained by division of the number of second pulses by the number of first pulses as a wheel diameter ratio, and periodically makes a comparison of the wheel diameter ratio, the wheel diameter ratio being a value obtained by division of a first wheel diameter of a first wheel attached to the first axle by a second wheel diameter of a second wheel attached to the second axle, and the control circuitry determines that the second wheel has worn, and corrects the second wheel diameter when the wheel diameter ratio exceeds a previous value of the wheel diameter ratio, and determines that the first wheel has worn, and corrects the first wheel diameter when the wheel diameter ratio falls below the previous value of the wheel diameter ratio.

8. A slip-slide detection method for use in a train control device to be installed on a train, the slip-slide detection method comprising:
by an acquisition circuitry, obtaining first pulses from a first velocity sensor for detecting the first pulses, and obtaining second pulses from a second velocity sensor for detecting the second pulses, the first pulses having been generated on a first axle of the train, the second pulses having been generated on a second axle of the train;
by the acquisition circuitry, storing the first pulses and the second pulses in a storage circuitry; and
by a control circuitry, determining occurrence or non-occurrence of a slip or a slide of the train by comparison, with a pulse ratio in normal operation, of a pulse ratio between a number of first pulses detected during a time period in which the train traveled a given distance among the first pulses, and a number of second pulses detected during a time period in which the train traveled the given distance among the second pulses, the pulse ratio in normal operation being a pulse ratio when neither a slip nor a slide is occurring.

9. The slip-slide detection method according to claim 8, wherein
the given distance is an axle-to-axle distance of the train between the first axle and the second axle.

10. The slip-slide detection method according to claim 8, wherein
the first axle has front wheels attached to the first axle and the second axle has rear wheels attached to the second axle, the front wheels each being a wheel provided on the train at a forward position in a travel direction of the train, the rear wheels each being a wheel provided on the train at a rearward position in the travel direction of the train.

11. The slip-slide detection method according to claim 8, wherein
the control circuitry detects the number of first pulses and the number of second pulses in each of a plurality of measurement periods, consecutive ones of the measurement periods partially overlapping each other in time, and
in determining occurrence or non-occurrence of the slip or the slide of the train, the control circuitry checks the pulse ratio at an interval equivalent to a shift amount of a start time of each of the measurement periods.

12. The slip-slide detection method according to claim 8, wherein
in determining occurrence or non-occurrence of the slip or the slide of the train, the control circuitry determines that neither a slip nor a slide has occurred on the train when a difference between the pulse ratio and a normal-operation pulse ratio is less than a threshold, and determines that neither a slip nor a slide has occurred on the train when the difference between the pulse ratio and the normal-operation pulse ratio is greater than or equal to the threshold.

13. The slip-slide detection method according to claim 12, wherein
in determining occurrence or non-occurrence of the slip or the slide of the train, the control circuitry determines that a slip or a slide has actually occurred on the train when a number of consecutive determinations that a slip or a slide of the train has occurred is greater than or equal to a given number of times, and determines that neither a slip nor a slide has actually occurred on the train when the number of consecutive determinations that a slip or a slide of the train has occurred is less than the given number of times.

14. The slip-slide detection method according to claim 8, further comprising:
by the control circuitry, calculating a value obtained by division of the number of second pulses by the number of first pulses as a wheel diameter ratio, and periodically making a comparison of the wheel diameter ratio, the wheel diameter ratio being a value obtained by division of a first wheel diameter of a first wheel attached to the first axle by a second wheel diameter of a second wheel attached to the second axle, and by the control circuitry, determining that the second wheel has worn, and correcting the second wheel diameter when the wheel diameter ratio exceeds a previous value of the wheel diameter ratio, and determining that the first wheel has worn, and correcting the first wheel diameter when the wheel diameter ratio falls below the previous value of the wheel diameter ratio.
